(19) United States
(12) Patent Application Publication
(10) Pub. No.: US 2016/0283691 A1
(43) Pub. Date: Sep. 29, 2016

(54) System, Method and Container Assembly for Prevention of Drug Diversion and for Compliance Assurance

(71) Applicant: Ammar Ali, Marshall, MN (US)

(72) Inventor: Ammar Ali, Marshall, MN (US)

(21) Appl. No.: 14/665,478

(22) Filed: Mar. 23, 2015

(51) Int. Cl. G06F 19/00; H04N 7/18

(52) U.S. Cl. CPC G06F 19/3456; H04N 7/183

(57) ABSTRACT

A system, method and container assembly for prescription drug diversion prevention and for prescription drug compliance assurance is presented herein. Particularly, the container assembly comprises a secure, tamper-resistant configuration with a locking assembly structured to prevent unauthorized access therein. A drug retention device is rotationally disposed within the container for controlled alignment with an access port, where a patient can remove a dose of medication. A control assembly is provided for recording the patient's removal and administration of the medication with a video camera and for determining whether access can be provided to a dose based upon a prescription regimen.

### FIELD OF THE INVENTION

The present invention is generally directed to a system, method and container assembly for prevention of prescription drug diversion and compliance assurance. Particularly, the invention will ensure precise control and automatic recording of intake time and video monitoring of the process of medication dispensing and medication intake by the patient for the purpose of prescription drug diversion prevention and/or ensuring compliance. For instance, a camera or other image recording device will record the patient taking possession of the medication and administering the medication, and the resultant media is communicated to a remote management system where the process of medication intake can be monitored or analyzed by trained staff. Then a report can be sent to third parties, for example, a prescribing physician, medical personnel, law enforcement, or family. Some embodiments may store the media locally on a local control unity (e.g., smartphone, tablet, etc.) either initially for subsequent communication to the remote management system or for subsequent review directly on the control unit.

### BACKGROUND OF THE INVENTION

Drug diversion and abuse of prescription medication is a serious problem in the United States and Worldwide. For instance, the term “drug diversion” or diversion of licit drugs for illicit purposes (as defined by drugwarfacts.com, for example) is used herein to mean that the prescribed medications (including prescription medications, controlled substances, etc.) that are prescribed to real patients for a true illness are diverted from the original, intended or medical purposes and are instead used for recreational purposes or provided to other people who use them for recreational purposes.

When physicians prescribe medications to a patient, there is no way of knowing if the patient took the medication, sold the mediation or shared the medication with others. There is also no way of knowing if the patient used the entire prescription or only a portion of the prescription and diverted the rest.

Due to concerns about drug diversion, millions of extremely sick but honest patients and individuals live everyday with pain, anxiety and medical symptoms (including for example ADHD), because their doctors are hesitant to prescribe controlled medications due to concerns about addiction, abuse, and diversion. For example, many patients who request pain medications from their doctors may be labelled as drug seekers which make it more difficult for the patients to obtain the medications they truly need. They may often turn to street drug dealers to obtain the medications and oftentimes become another victim of addiction that could have been prevented if their needs were addressed and taken care of by proper medical avenues.

In addition, drug diversion can cause thousands of patients to be sent to jail for selling, distributing or simply sharing their medications. Further, as a result of drug diversion, approximately fifteen thousand individuals die every year due to the misuse of legally prescribed medications.

Accordingly, there is a desperate need in the art for a system, method and device that would control the distribution and access to controlled substances and other medications, including dangerous pain medications and scheduled medications, and that would aim to minimize or eliminate drug diversion. The proposed system, method and device can also be helpful for mentally ill patients or individuals with psychiatric illnesses that impair judgment and insight about their illness and the need to take the medications.

Further, the proposed system, method and device will advantageously resolve the doctor's inability to identify partial users, e.g., users who consume some of the medication but divert the rest. The system and method of the proposed invention may also include a staff or individuals who will monitor data, images, and video generated by the device and provide monthly or other periodic reports to the prescribing doctor, for instance, at the time of prescribing the next refill. In this manner, the doctor will have a visual, simple-to-read report and video recordings of their patient's use, timing and proper handling of the medication.

For instance, the proposed system, method and device may include recorded video of the patient handling and taking the medication. An independent staff member may review the video footage or recorded images and ensure that the medication was actually taken by the patient to whom the prescription belongs. Any improper use of medication, such as “cheeking” (i.e., pretending to swallow the medication by hiding the medication in part of the mouth, such as between the gums and cheek) can be identified by the staff member or third party reviewer. For this reason, the camera or image capturing device of the proposed invention will be on until the patient has swallowed the medication, and until the patient has shown the inside of their mouth to the camera, moving his or her tongue in all direction (up, down, left, right) to show that they have swallowed the medication and no “cheeking” or improper activities have occurred.

Data obtained by the system, method or device can be communicated, in real-time, to a central or remote database where the history of the medication use and the video or image recordings can be accessed or viewed. Reports can be generated and communicated to physicians, nurses, judges, law enforcement officers, probation officers, court systems, family members, guardians, or other authorized third parties with the patient's express consent and approval.

### SUMMARY OF THE INVENTION

The present invention is generally directed to a system, method and container assembly for prevention of prescription drug diversion and compliance assurance. Particularly, the container assembly of the various embodiments of the present invention is structured to control access to prescription medication, drugs, controlled substances, etc. based upon a predetermined prescription regimen. A video/still image camera or other image recording device will record media (e.g., video and/or images) of the patient taking possession of the medication and administering the medication, and the resultant media is communicated to a remote management system where it can be monitored or analyzed, for example, by a physician, medical personnel, law enforcement, or family. In some embodiments, it should be noted that the media captured by the image capturing device, as well as other data corresponding to the patient access (e.g., date, time, username, patient name, etc.) may be stored locally on the device or control unit itself, such as a smartphone tablet, or other control unit. The recorded data and/or media can be reviewed by the doctor or other authorized party, for example, by bringing the smartphone, tablet, or the control unit/assembly to the doctor. In other embodiments, the data or media may be reviewed remotely by trained staff where a report can be generated and submitted or communicated to the doctor, for example, or other authorized party. The control unit/assembly can be physically brought or mailed to the trained staff for review and analysis.

Specifically, in order to gain access to the medication, one dose or one pill at a time, in at least one embodiment, the patient must first enter a code or other authenticating information (e.g., biometric fingerprint information, password, swipe or scan driver's license, etc.) Once authenticated, the system, method and device will analyze or process the patient's prescription regime (or details provided by the physician as to the frequency or allowed medication use) and in some cases, information relative to the patient's historical use (i.e., when was the last time he or she took a dose), to determine whether access can be granted.

If so, the control unit or control assembly will send a signal or impulse (e.g., via a connected cable or wirelessly) to a secure container which houses the medication. The signal will cause the container to be movably disposed (for example by rotating an internal drug retention device) such that a dose of medication is available via an access port. The patient can then remove and take the medication.

Some embodiments may provide limitless access to the medication or other substance within the container, for example, depending on particular need, the prescription or other instructions.

Certain embodiments further include automatic activation of a video camera or image capturing device in order to record the patient removing the medication and taking the medication. In this manner, the patient may be required to face the camera and show the camera that he or she properly took the medication and did not “cheek” the medication or otherwise hide it. Further embodiments may instruct or require the patient to also show the pill or other medication to the camera so the pill markings, indicia or identifying information is clear to the camera. This can indicate that the patient took the correct pill or medication.

The data (including the video, images, date, time, etc.) can be communicated to a remote management system and analyzed by authorized personal, such as trained staff members, or an automated software application or process. A report can be generated based upon the data and media, which can be provided to the physician, law enforcement, judiciary, family members or other third parties.

In addition, the container of some embodiments may include a locking assembly restricting access to the internal compartment of the container to only those authorized to have or gain access. For instance, pharmacists or physicians may have a key or access code that allows them to refill the container, as needed or prescribed. Other embodiments of the container assembly may include a sealed container such that no access (other than through the provided access port) to the internal compartment can be accomplished without breaking or destroying the container. In this regard, a pharmacist or other authorized party may be able to connect the container assembly to his or her computer, tablet, phone, or other control unit. The pharmacist control unit may grant limitless rotational or other movement access to the container allowing each of the separate compartments to be aligned with the port, filled and then rotated into the container. These and other objects, features and advantages of the present invention will become more apparent when the drawings as well as the detailed description are taken into consideration.

### BRIEF DESCRIPTION OF THE DRAWINGS

FIG. 1A is a perspective view of the drug dispensing assembly as disclosed in accordance with at least one embodiment of the present invention wherein the control assembly comprises a personal electronic device, such as a patient's cellular telephone, with a transparent picker disposed or removably attached to a surface thereof.

FIG. 1B is a perspective view of the drug dispensing assembly as disclosed in accordance with at least one embodiment of the present invention wherein the control assembly comprises a personal electronic device, such as a patient's tablet computer.

FIG. 1C is a perspective view of the drug dispensing assembly as disclosed in accordance with at least one embodiment of the present invention wherein the control assembly comprises a personal electronic device, such as a patient's laptop computer.

FIG. 1D is a perspective view of the drug dispensing assembly as disclosed in accordance with at least one embodiment of the present invention wherein the control assembly comprises a personal electronic device, such as a patient's desktop computer.

FIG. 2 is a perspective view of the drug dispensing assembly as disclosed in accordance with at least one embodiment of the present invention wherein the control assembly comprises a dedicated device.

FIG. 3 is another perspective view of the container assembly as disclosed in accordance with at least one embodiment herein.

FIG. 4 is a perspective view of the container assembly without a lid for illustrative purposes only.

FIG. 5 is a cut-away view of the container assembly as disclosed in accordance with at least one embodiment of the present invention.

FIG. 6 is a side view of the drug retention device and diving mechanism as disclosed herein.

FIG. 7 is bottom perspective view of the drug retention device and diving mechanism as disclosed herein.

FIG. 8 is a top perspective view of the body portion of the container assembly as disclosed in accordance with at least one embodiment herein.

FIG. 9 is a perspective view of the body portion of the housing and the driving mechanism as disclosed in accordance with at least one embodiment of the present invention.

FIG. 10A is a perspective view of yet another embodiment of the drug dispensing assembly of the present invention wherein the container assembly comprises an always closed configuration.

FIG. 10B is another perspective view of the drug dispensing assembly of the present invention wherein the container assembly comprises an always closed configuration.

FIG. 11 is a perspective view of the container assembly illustrated in the embodiment of FIGS. 10A and 10B.

FIG. 12 is a cut-away view of the container assembly illustrated in the embodiment of FIG. 11.

FIG. 13 is a schematic representation of the system for prevention of prescription drug diversion and compliance assurance as provided herein.

FIG. 14 is a block diagram of the system for prevention of prescription drug diversion and compliance assurance as provided herein.

FIG. 15 is a high-level flow chart illustrating the method for prevention of prescription drug diversion and compliance assurance as provided herein.

Like reference numerals refer to like parts throughout the several views of the drawings provided herein.

### DETAILED DESCRIPTION OF THE INVENTION

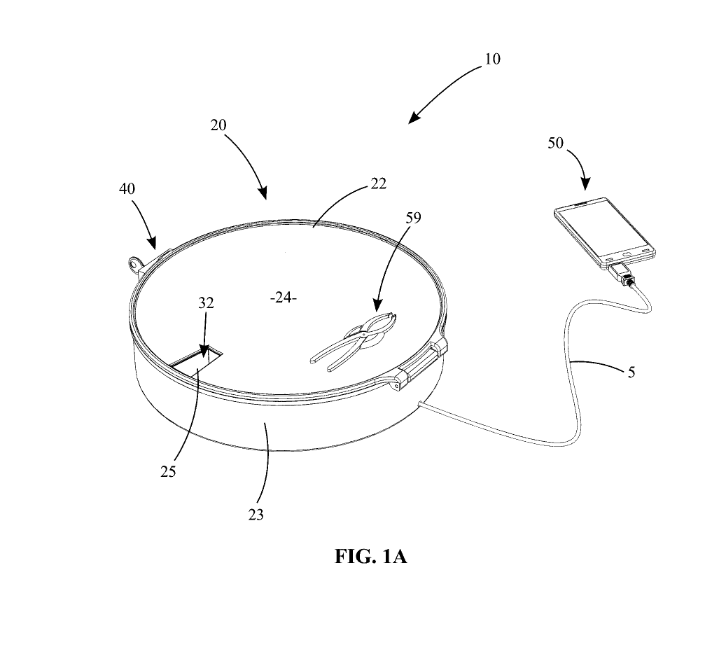

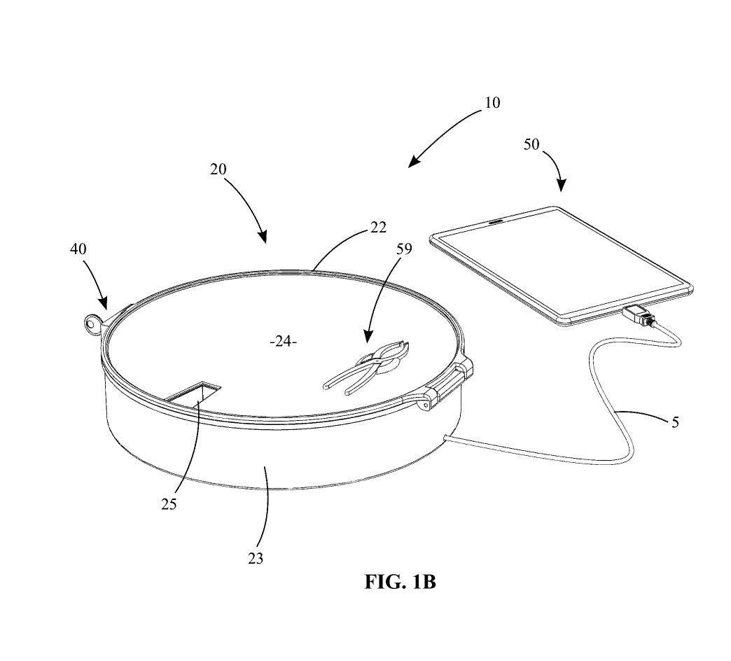

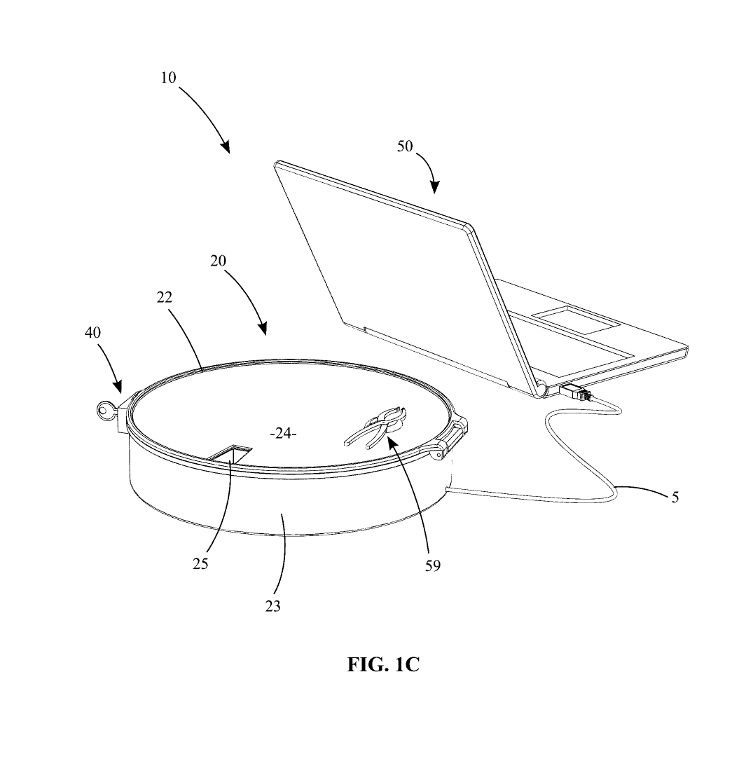

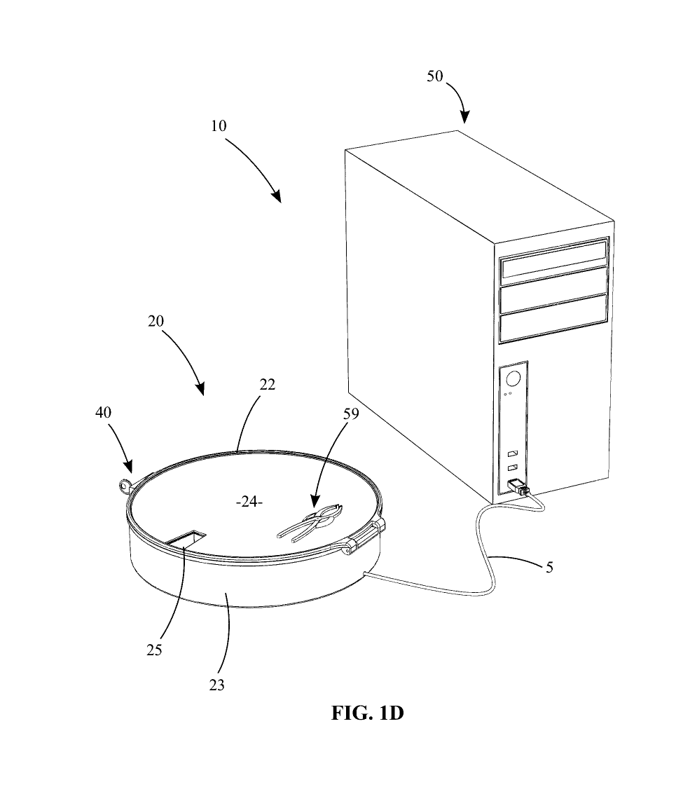

As shown in the accompanying drawings, and with particular reference to FIGS. 1A, 1B, 1C and 1D, for example, the present invention is directed to a drug dispensing assembly, generally referred as 10. In particular, the drug dispensing assembly of the various embodiments disclosed herein is structured and configured to restrict or control access to various prescription drugs, medications, pills, controlled substances, etc. In addition, as described herein, certain embodiments of the present invention are further directed to a system 100 and/or method 200 for prevention of prescription drug diversion and compliance assurance.

Particularly, still referring to FIGS. 1A, 1B, 1C and 1D, the drug dispensing assembly 10 of at least one embodiment of the present invention includes a container or container assembly 20 with a substantially enclosed housing 22. For example, certain embodiments of the housing 22 are defined by a base or body portion 23 and an attached lid 24, although other configurations and structures may be implemented to define or construct the housing 22 of the present invention. In addition, the container 20, including the base 23 and/or lid 24, may be constructed of a substantially durable and tamper-resistant material such as acrylonitrile butadiene styrene (ABS) plastic or other plastic material, metal, etc. or combinations thereof.

Furthermore, as shown in the embodiments illustrated in FIGS. 1A, 1B, 1C and 1D, for example, the container assembly 20 and/or housing 22 thereof is structured to include an access port 25, which, as will be described herein, provides selective and/or controlled access to the a portion of the contents disposed within the container 20, such as, for example, one or more doses of prescription medication, drugs, controlled substances, etc.

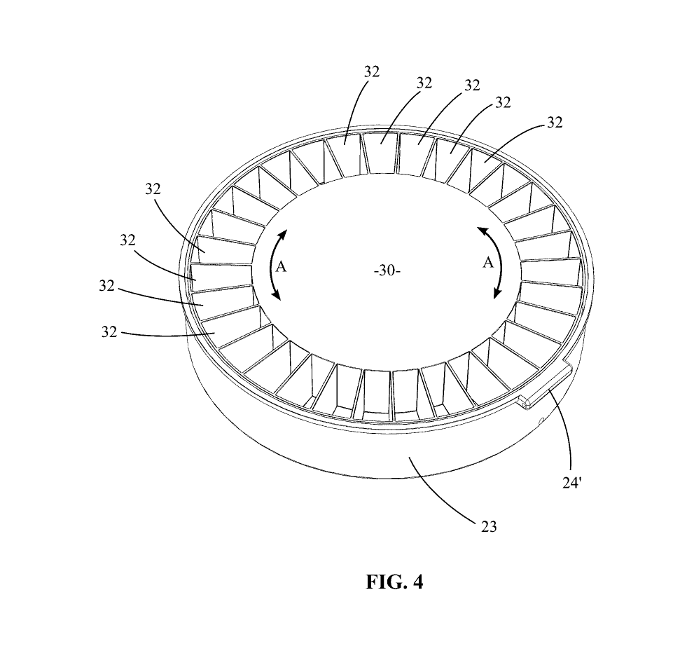

Referring now to FIG. 4, the lid 24 is removed or otherwise not shown for purposes of illustration and description. Particularly, disposed on the interior portion 21 of the container assembly 20 of at least one embodiment is a drug retention device 30 for at least temporarily storing or retaining the drugs or medication. Specifically, the drug retention device 30 illustrated in FIG. 4 comprises a generally disc-shaped configuration with a plurality of individual compartments 32 disposed along or proximate a peripheral circumference or edge thereof. The individual compartments 32 of certain embodiments are sized and shaped to retain or store at least one dose, at least one pill, drug, or other controlled substance. For instance, it should be noted that each one of the individual compartments 32 of at least one embodiment may be structured, sized or configured to retain a single pill or a single dose (e.g., two or more pills). The invention should not be limited to retaining and dispensing pills, however, in that other forms of medication or prescriptions may be contained or at least temporarily retained in the drug retention device 30 of the various embodiments of the present invention.

Accordingly, in the exemplary embodiment shown in FIG. 4 (wherein the lid 24 is not shown, for illustrative purposes only), the drug retention device 30 is rotationally disposed within the container assembly 20, as generally illustrated by arrows A. For instance, although arrows A are double-ended, illustrating movement in both directions, some embodiments may only rotate in one direction, whereas other embodiments or implementations may rotate in both clockwise and counter-clockwise directions. Particularly, as the drug retention device 30 rotates or moves within the container 20, one of the individual compartments 32 will become aligned with the access port 25 at a time. In this manner, the access port 25 and the individual compartments 32 may be cooperatively sized such that access to one and only one individual compartment 32 is granted at a time. Particularly, as the drug retention device 30 is movably or rotationally disposed within the container 20, the individual compartments 32 will be exposed one-by-one through the access port 25. Other embodiments or implementations may allow access to multiple compartments 32 at a single time, for instance, depending on the dose or the prescription regimen.

In addition, although the access port 25 of the embodiments shown in the Figures is disposed proximate the outer peripheral edge of the lid 24 or top portion of the container assembly 20, it should be noted that the access port 25 may be in other locations and still fall within the full spirit and scope of the present invention. For example, the access port 25 may be disposed further inward on the top portion or lid 24. Other embodiments may include an access port 25 on the side of the housing, for example, on the side of body portion 23, or in some cases, on the bottom of the housing. Of course, the drug retention device 30 and the individual compartments 32 can be constructed in different locations, orientations, sizes and shapes to correspond with the access port and/or particular medication or application.

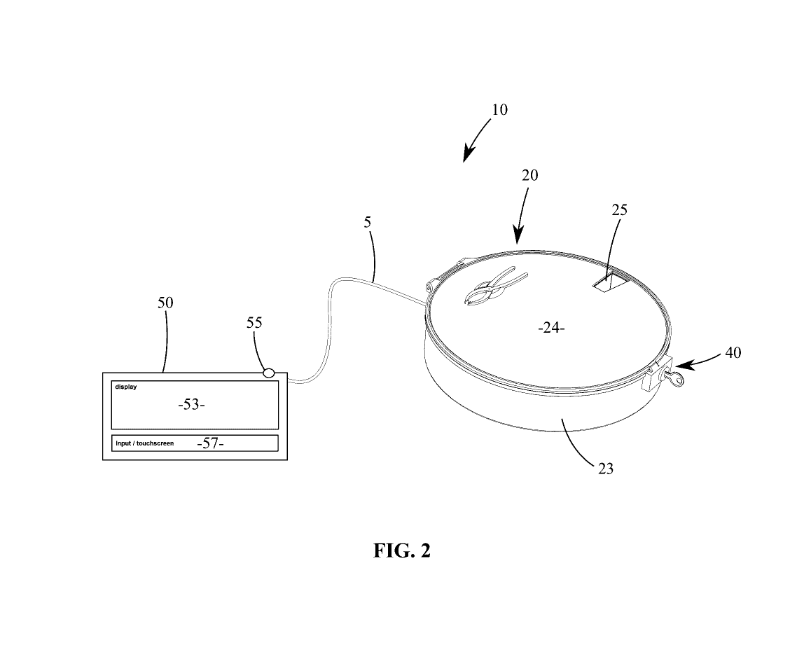

Additionally, referring again to FIGS. 1A, 1B, 1C, 1D and 2, certain embodiments of the present invention further include an electronic control assembly 50 communicatively connected with the container assembly 20, either via a wired connection (e.g., universal serial bus (“USB”) connection 5), short-range wireless connection (e.g., Bluetooth, Zigbee, WiFi connection) or long-range/remote connection (e.g., Internet or World Wide Web connection). In any event, the control assembly 50 of the various embodiments of the present invention is structured to actuate the container assembly 20, for example, via an electrical signal, impulse, etc. Actuation of the container assembly 20 will cause one of the individual compartments 32 of the drug retention device 20 to align with the access port 25 for selective and controlled removal of the medication or drugs contained therein, for example, by a patient.

For instance, when the control assembly 50 sends an actuation signal to the container assembly 20 of at least one embodiment, the drug retention device 30 will rotate or otherwise be movably disposed within the container to align one of the compartments 32 (for example, a compartment 32 containing a pill, a dose, or medication) with the access port 25. Accordingly, in one embodiment, each time the control assembly 50 actuates the container assembly 20, the drug retention device 30 may be rotated or moved within the container to expose the very next or adjacent compartment 32. In this manner, the drug retention device 30 will progressively move a predetermined amount or distance each time the container assembly 20 is activated, thereby exposing the very next or adjacent compartment 32 via the access port 25. For instance, certain embodiments may include a sensor (e.g., optical sensor), control apparatus, computer processor, or other devices or mechanisms to control the movement or rotation of the drug retention device 30 upon actuation of the container assembly 20 via the control unit or control assembly 50. As an example, an optical sensor (not shown) may be disposed within one or more the compartments 32 (or elsewhere) to sense when the drug retention device 30 has rotated or moved a sufficient amount to expose the next compartment 32. Of course, other sensors, devices, etc. may be implemented within the full spirit and scope of the present invention.

Rather than movement or rotation to expose the very next or adjacent compartment 32 through the access port 25, other embodiments may allow or include a more controlled or customized movement of the drug retention device 30 such that the actuation signal communicated from the control assembly 50 to the container assembly 20 may also include an indication as to how much or how far the drug retention device 30 should be moved or rotated. Therefore, in this example, the drug retention device 30 may rotate or move different distances, for instance, depending on which compartment 32 contains the drugs to be dispensed (which may, in some cases, not be the next immediate or adjacent compartment).

Furthermore, it should be noted that the control assembly 50 of at least one embodiment may be structured to only provide access to the drugs (e.g., by actuating the container assembly 20 and rotationally or movably disposing the drug retention device 30 to align a compartment 32 containing a drug or drug dose with the access port 25) according to an access control prescription regimen, for example, a regimen provided by or defined by a prescribing physician. In this manner, the control assembly 50 of at least one embodiment may comprise a storage device which is structured to store a prescription regimen by which the control assembly 50 is structured to follow. Other embodiments, may store a prescription regimen on a remote server or remote database, which the control assembly 50 accesses, for example, via the Internet, or other remote connection or network(s).

For exemplary purposes only, a prescription regimen, as used herein, may be defined as set of rules or parameters that allow or require a patient to take, consume or otherwise administer a certain dose or number of doses of a medication a defined number of times or via defined temporal or other parameters. As an example, a prescription regimen may include a single pill or dose once a day, twice a day, three times a day, every hour, every two hours, etc. for a week, two weeks, etc. Accordingly, in order for a patient or user to activate the control assembly 50 or otherwise request that the control assembly 50 actuates the container assembly 20, in at least one embodiment, the patient or user will request, via appropriate inputs on the control assembly 50, that a dose or medication be made available via the access port 25. The control assembly 50 will process the patient's request according to the applicable access control prescription regimen, and if the regimen allows access to the medication, drugs or dose, a signal is communicated from the control assembly 50 to the container assembly 20, and the drug retention device 20 is rotated or movably disposed within the housing in a manner to expose a dose or drug via the access port 25.

It should also be noted that in certain embodiments, the control assembly 50 may require the patient or user to enter a password or other authentication in order to request a dose or access to the drugs or medication. The authentication may include, but is in no way limited to, a username and password, numerical code, biometric (e.g., fingerprint) authentication, etc.

Furthermore, as shown in the embodiment illustrated in FIGS. 1A, 1B, 1C and 1D, the control assembly 50 of at least one embodiment may include a personal electronic device, such as, for example, the user's or patient's personal cellular phone, smartphone (FIG. 1A), tablet (FIG. 1B), laptop computer (FIG. 1C), desktop computer (FIG. 1D) or other electronic device. In this manner, the control unit or control assembly 50 may include a mobile or other software application (e.g., downloaded and installed, or remotely accessible) that contains or accesses the patient's profile, prescription regimen(s), etc. Other embodiments, as shown in FIG. 2, for example, may include a dedicated control assembly 50 with a display screen 52, input device 53, etc. and connected to the container assembly 20 via a cable 5, or wirelessly as described herein.

Furthermore, the control assembly 50 of certain embodiments further includes a video or image recording device 55, such as a camera that can capture various media such as still and/or moving images, as well as audio. A stand (not shown) or other support may be provided or included which is structured to hold the control assembly 50 and position the control assembly 50 toward the patient and/or the container 20 during removal of medication from the container 20 and administering of the medication. For instance, in at least one embodiment, the control assembly 50 may be configured (for example, via a mobile application or dedicated application) to automatically activate the image recording device 55 upon a predetermined event, such as, when the patient requests access to the medication, when the access is granted (or denied), when the actuation signal is communicated to the container assembly 20, or when the next compartment 32 of the drug retention device 30 is aligned with the access port 25 thereby exposing the medication. Video or images of the patient or user removing the medication and administering the medication can be recorded and saved, either locally on the control assembly 50 or remotely via a remote management system, as described further below.

Accordingly, the patient may be required to remove the medication from the container 20 and bring it close to the camera or image recording device 55. As an example, one embodiment of the invention may include a picker 59, for example, a set of tongs or other gripping devices, that allow the patient to easily remove the medication from the container 20 (e.g., by grabbing onto the medication with the picker 59, pulling it out of the compartment 32 and through the access port 25). The picker 59 may be removably attached or secured to the container, for example, removably secured to a surface of the container by one or more clips, magnets, snaps, or other cooperatively structured attachment devices. The picker 59 may be removed from the attachment device and used to pick grab onto the medication, for example, through the access port 25. In this manner, the patient may remove the medication either by using the picker 59, his or her hands, or other methods and show the medication to the camera or image recording device 55 so that identifying information relative to the medication can be recorded, such as, for example, the shape, color, number or indicia, etc.

In at least one embodiment, the picker 59 is substantially transparent. For instance, by having a transparent picker 59, it may be more difficult for a patient to deceive the system or method by, for example, having another pill or medication in hand before actuation of turning on the dispenser assembly 10, and consuming or swallowing that pill rather than the controlled substance or drug contained in the dispenser assembly 10. For instance, the patient may hold a (deceptive) pill in hand, activate the dispenser assembly 10, swallow the (deceptive) pill and divert the pill from the container or dispenser assembly 10. A transparent or clear picker 59 may be used to minimize this deception, in that the patient may have to, or be instructed to, remove the drug from the container with the transparent picker 59 (which is captured on video), and consume the drug removed from the dispenser assembly 10 and held by the picker 59. The transparent nature of the picker 59 of one embodiment helps minimize the potential deception and drug diversion tactics.

Furthermore, the patient may place the medication into his or her mouth (or other method of administration) with the patient's entire face and neck showing to the camera. The patient may then be directed by the system to open his or her mouth facing the camera right after swallowing and move his or her tongue up and down, left and right, before the camera stops recording. Various information or prescription access media is recorded and saved each time the patient administers medication. For example, the prescription access media may include, but is in no way limited to, video or images obtained via the camera or image recording device, the date and time of access, frequency of use, etc.

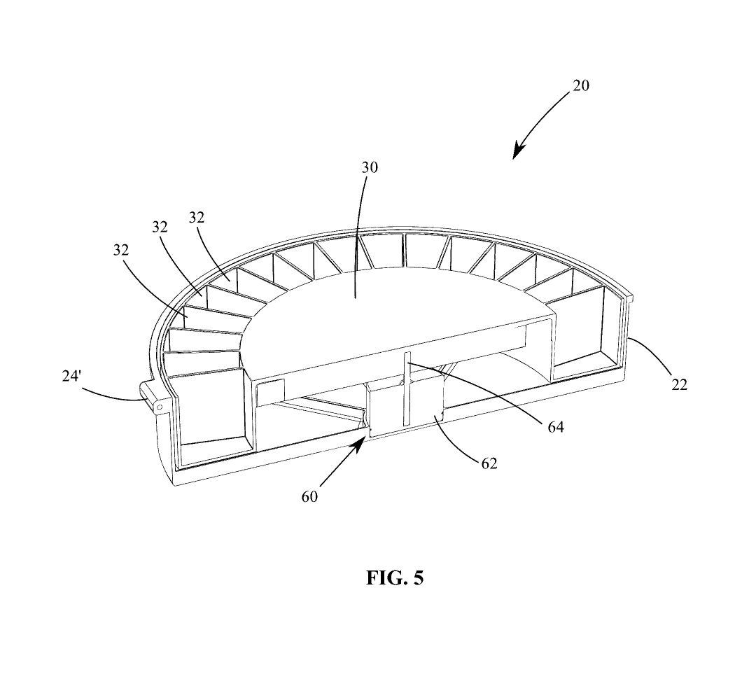

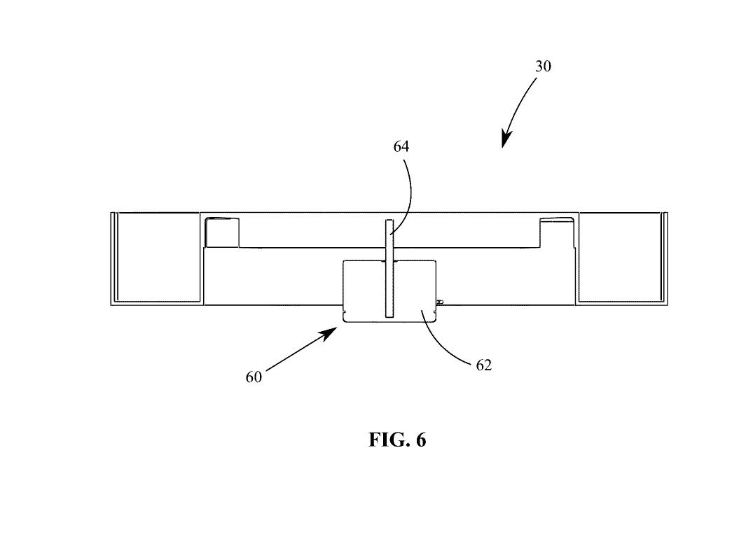

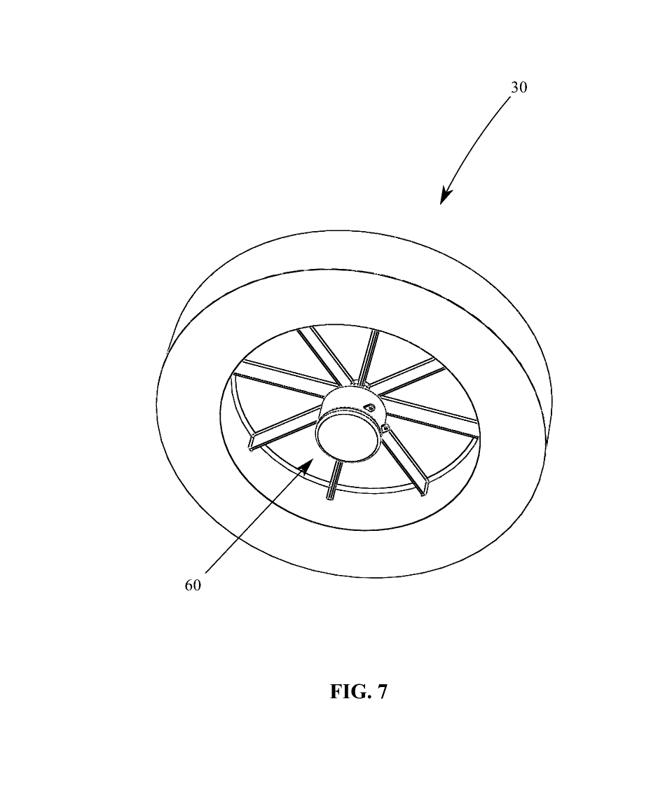

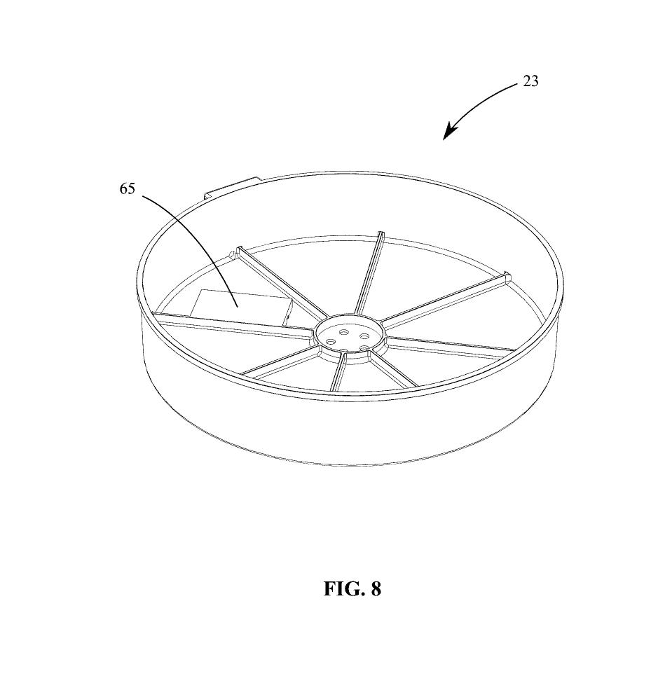

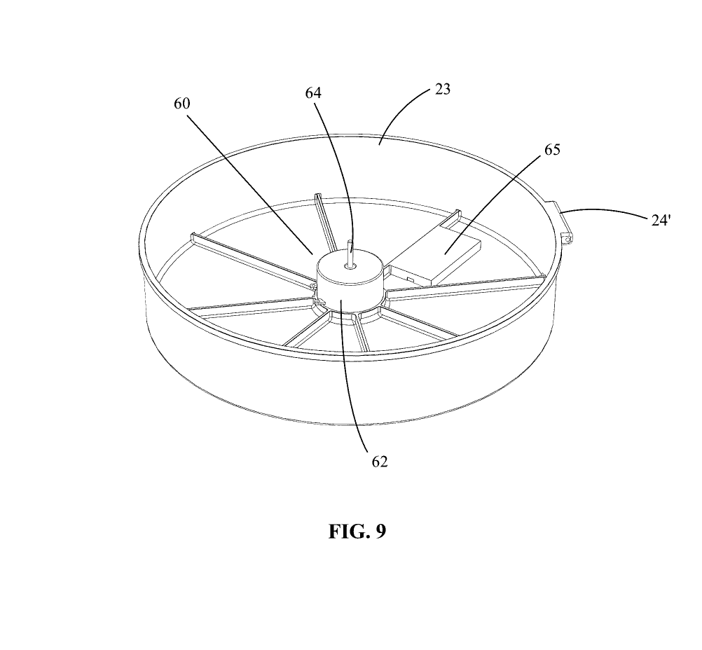

FIGS. 5 through 9 illustrate various angles and/or cut-away views of the container assembly 20 or portions of the container assembly 20, showing a driving mechanism 60 of at least one exemplary embodiment that is used to rotate or movably dispose the drug retention device 30 within the container 20. For instance, the driving mechanism 60 may include a motor seated within the container and structured to engage the drug retention device 30 for movement thereof. The driving mechanism 60 may include a base portion 62 which is fixedly secured to the container 20, such as, for example, the body 23 portion thereof. A rotating rod 64 may extend from the base 62 of the motor 60 and engage the drug retention device 30. In this manner, rotation of the rod 64 will cause the drug retention device 30 to correspondingly rotate within the container 20.

The motor or driving mechanism 60 may be connected to a power source, such as a battery or batteries 65, external power cable, etc. In other embodiments, the motor or driving mechanism 60 may obtain power from the control assembly 50, which may be battery powered or include a separate cable that may be plugged into an external power source such as a power outlet.

It should also be noted that other embodiments or implementations of the present invention may include a rotating lid or rotating access port 25, wherein the drug retention device 30 remains stationary. For instance, the driving mechanism 60 may rotationally or movably engage the lid or other portion of the container 20 thereby moving the container 20 or portions of the container 20, such as the access port 25 into an aligned relation with the compartments 32 of the drug retention device 30.

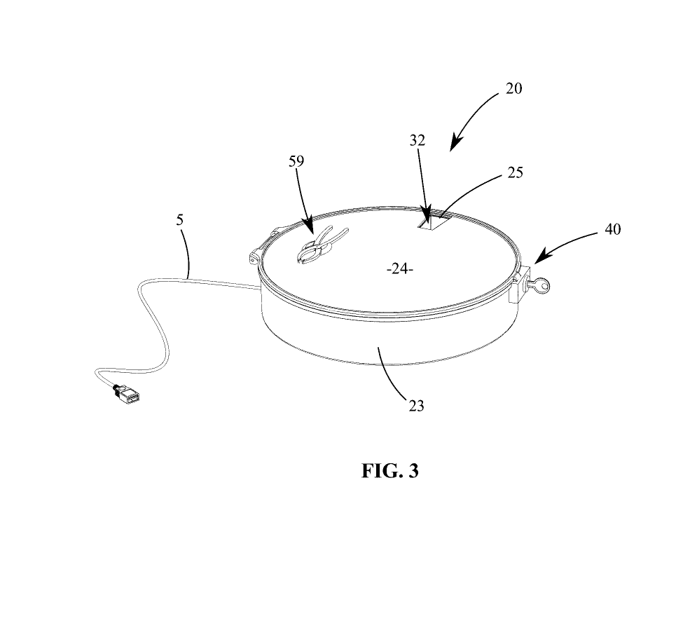

Additionally, in at least one embodiment, access to the interior portion 21 of the container 20, other than via the access port 25, may be restricted via a locking assembly, generally referenced as 40 in FIGS. 2 and 3, for example. Particularly, the locking assembly 40 of at least one embodiment is structured to restrict access to the drugs, medication, or prescriptions, for example that are retained within the interior portion 21 of the container 20 and not exposed via the access port 25. Access may be provided, for example, to only pharmacists, physicians, or other medical personnel or professionals that are licensed or authorized to replenish, replace, or fill the container 20 with the medication, drugs, etc. As such, the locking assembly 40 of at least one embodiment may include a lock and key, as generally illustrated in FIGS. 2 and 3, wherein the key is required to unlock the locking assembly 40 and gain access to the interior portion 21 of the container 20. As such, the pharmacist(s), physician(s), or other authorized party may possess a key or other device that is capable of unlocking the locking assembly 40 and thereby gain access to the interior portion 21 of the container 20. It should be noted, however, that other locking assemblies 40 may be implemented within the scope of the present invention, including, for example, biometric access restriction devices, keypads, combination locks, electronic locks, locks that require entry of a username and password, RFID locks, etc.

Other embodiments, may provide access by connecting the container assembly 20 to a control unit (e.g., smartphone, tablet, computer, laptop, etc.) which can communicate an access signal to the container assembly 20 which may unlock the locking assembly 40. Thus, a physical key may not be needed in some implementations wherein the pharmacist or other authorized party can connect the container assembly 20 to a control unit 50, enter authenticating information (e.g., username, password, biometric, etc.) If the pharmacist or other party is authenticated as a user who can access the interior portion 21 (e.g., to refill the container), the access signal is communicated from the control unit 50 to the container assembly 50, unlocking the locking assembly 40.

For example, and still referring to FIG. 4, in one exemplary embodiment, the container 20 includes a base or body 23 and a lid 24, wherein the lid 24 is lockingly engaged to the base or body 23 via the locking assembly 40. Unlocking the locking assembly 40, in the embodiment shown, will allow the lid 24 to pivot upward, for example via hinge 24′, providing access to all of the individual compartments 32 of the drug retention device 30. The hinge 24′ of at least one embodiment may include a steel pin slidingly engaged within corresponding holes or portions of the lid 24 and base 23. As an example, the steel pin may be approximately 3 mm in diameter and 80.4 mm in length, however, other dimensions and other hinge assemblies are contemplated.

It should also be noted that other configurations of the container 20 itself are contemplated within the full spirit and scope of the present invention, such as a container with a sliding lid, or a side door that allows the drug retention device 20 to be slidingly engaged into and out of the housing, etc. Furthermore, the container 20 of the various embodiments of the present invention should not be limited to a circular or disc-shaped configuration, in that other shapes, sizes, and configurations are contemplated within the full spirit and scope of the present invention in order to accommodate various uses, drugs, medications, etc.

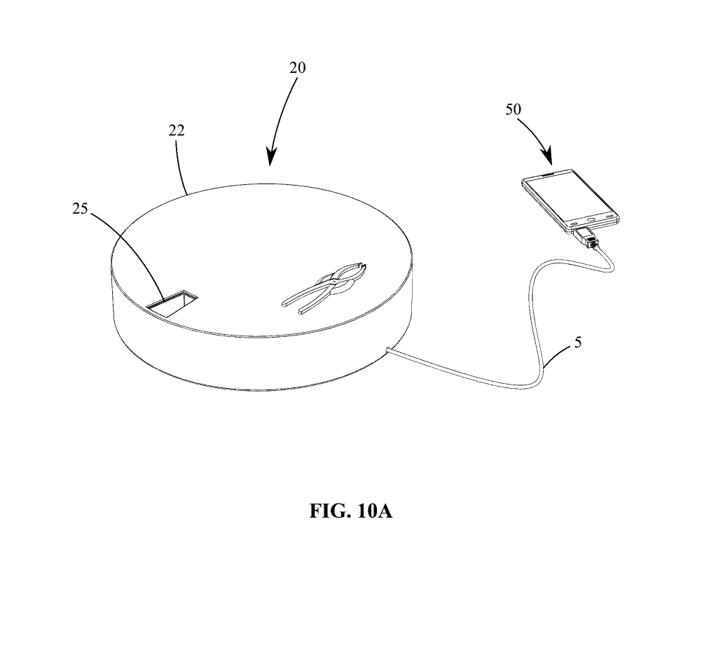

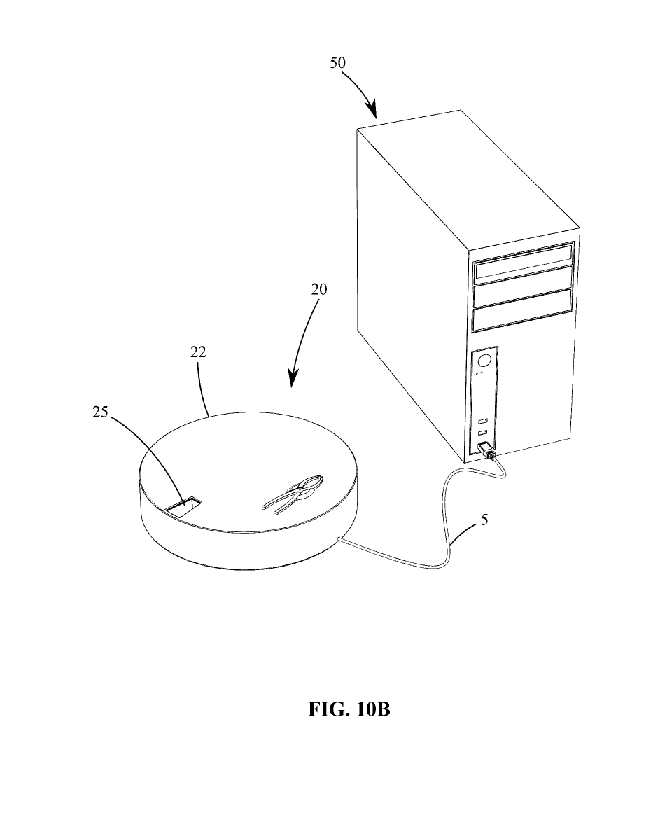

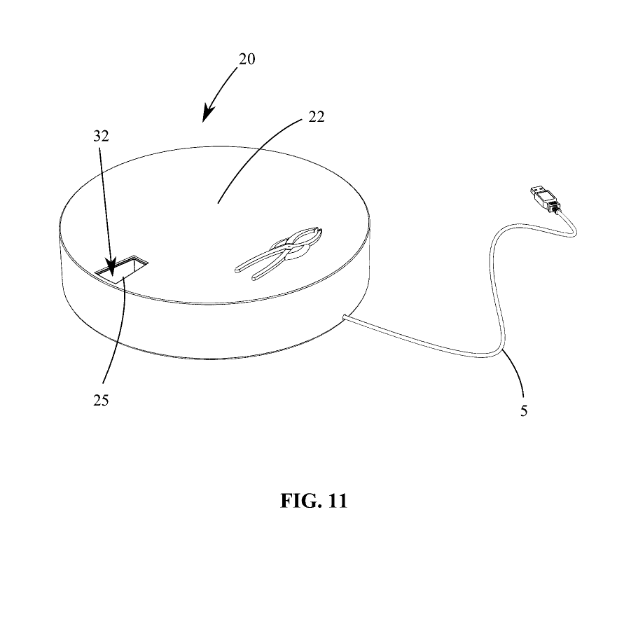

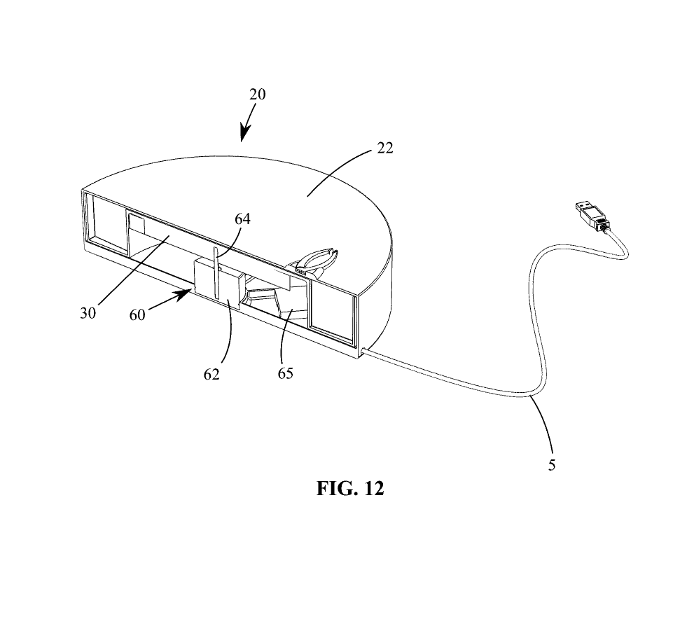

Referring now to FIGS. 10A, 10B, 11 and 12, yet another embodiment of the container assembly 20 is presented. For instance, the container assembly 20 shown in FIG. 10A, 10B, 11 and 12 comprises a sealed container 20 with no removable or pivoting lid. Rather, the only access to the interior portion of the container 20 is through the access port 25. Specifically, the housing of the container 20 may include a single piece construction, or may include assembled portions that are not intended to be removed or otherwise opened to gain access to the interior portion of the container 20 (other than via the access port 25).

Accordingly, the pharmacists, physician or other authorized party who may want to fill the prescription (e.g. by placing medication into the compartments 32 of the drug retention device 30), empty the contents of the container 20, etc. may only do so by accessing each of the compartments 32 one-by-one via the access port 25. For instance, by using a control unit or control assembly 50, the user (e.g., pharmacist) may enter one or more appropriate authenticating items (e.g., username, password, biometric access credentials, etc.) and gain administrative control over the rotation or movement of the drug retention device 30. Particularly, with the appropriate credentials, the user of at least one embodiments will be able to movably dispose the drug retention device 30 to continuously or sequentially align the compartments 32 with the access port 25, allowing the user to fill or empty the compartments one by one. In this manner, the rotation or movement of the drug retention device 30 will not be limited by a prescription regimen because the pharmacist will need access to a plurality of the compartments 32 in order to fill them with the prescription.

Additional features of at least one embodiment of the present invention may include one or more software applications that can be downloaded, installed or otherwise accessed via the control assembly 50, as described herein. For instance, at least one embodiment includes a patient access software application wherein the patient may log into the application and provide access credentials to activate the container assembly, as described herein. The access media (e.g., the date, time, and video recorded) corresponding to the patient's access of the prescription or other medication can be stored locally on the control assembly 50 itself. This provides a significant amount of privacy in that the media will not be transmitted from the control assembly 50, such as the patient's smartphone, tablet or computer, to a remote location. Observation or review of the media, for example, by the prescribing physician, law enforcement, etc., can be conducted by direct review on the patient's control assembly 50 without transmitting the media.

Other patient applications may transmit the access media to a remote server or other remote location, such as a remote management system. The access media can then be reviewed remotely, by trained staff or by a prescribing physician, law enforcement, family member(s), caregiver(s), etc.

In any event, the patient application of the various embodiments will control the container assembly 20 in that the container assembly 20 will not dispense or provide access to the medication without the patient application being activated by the appropriate user or patient. For instance, when the patient or authorized user enters the appropriate authentication information, in at least one embodiment, the following actions will automatically occur: (1) the camera or image capturing device of the control assembly will turn on for a predetermined amount of time, and (2) an electrical signal or impulse will be delivered from the control assembly to the motor or other driving mechanism in the container assembly in order to move the drug retention device just enough to expose one compartment. These actions may occur simultaneously in some embodiments or at different times in other embodiments.

Furthermore, an administrative application, software or permission control may be implemented in order to allow those authorized individuals or parties to have unlimited access to all of the patient profile information and access media in the database. Thus, the administrative application or permission control may allow those authorized individuals to view all of the videos and to assess the process of the medication intake (i.e., and make a determination as to whether the medication intake was proper or improper.) This information can then be provided to a third party reviewer such as the prescribing physician, family member, etc., in the form of a monthly or other periodic report.

Yet another application, software or permission control may include a third party reviewer application or permission intended for third party reviewers such as physicians, doctors, nurses, judges, social workers, probation officers, guardians, authorized family members, etc.) In certain embodiments, the third party must have the patient's consent to access the file, profile, media or information. In some embodiments, the third-party reviewer can only gain access to the information for the particular patient(s) he or she has taken care of, are taking care of, etc. for instance, a physician can only have access to his/her patients or those patients who have authorized the physician to have access to the file(s).

In a further embodiment, a pharmacist application, software or permission control may be implemented. For instance, a pharmacist may be able to access the application in order to fulfill a prescription and fill the container assembly accordingly. Specifically, in one embodiment, particularly in the embodiment wherein the container assembly cannot be opened (such as when the housing is a single piece or always closed configuration) the pharmacist application, software or permission control may be used to limitlessly move or rotate the drug retention device within the container assembly, for example, without regard to a prescription regimen or restriction on timing, and without activating the camera. This allows the pharmacist to fill a compartment through the access port, rotate the drug retention device, fill the next compartment, rotate the drug retention device, fill the next compartment, rotate the drug retention device, etc.

Each of the applications or software (patient application/software, administrative application/software, third-party reviewer application/software and pharmacist application/software) may be downloaded from a website or application store, however, some of the applications (e.g., the administrative application, third-party reviewer application and pharmacist application) may require an authenticating access number to download. Other embodiments may allow the applications to download, however, access code, password or other authentication must be entered to use the application in the intended manner. It should also be noted that a single application may be implemented to accomplish or accommodate one or more of the various access control permissions, described above (e.g., with regard to the patient, administrative access, third-party reviewer access, or pharmacist access), wherein the log-in credentials will determine what access, permission or control is provided. In some embodiments, patient registration requires a social security number or other unique access number in order to prevent or minimize doctor shopping (i.e., visiting multiple doctors to obtain multiple prescriptions).

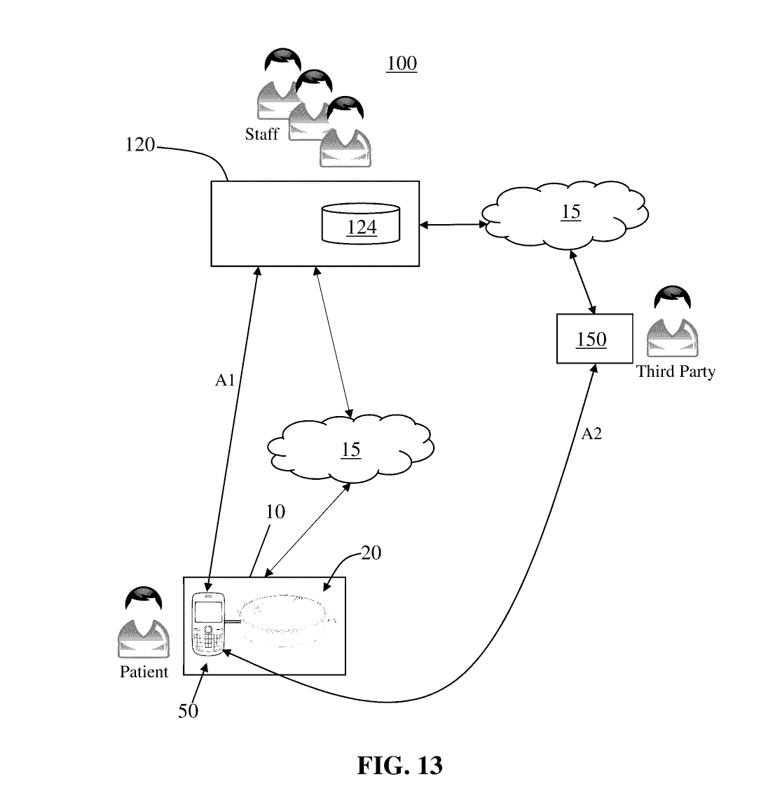

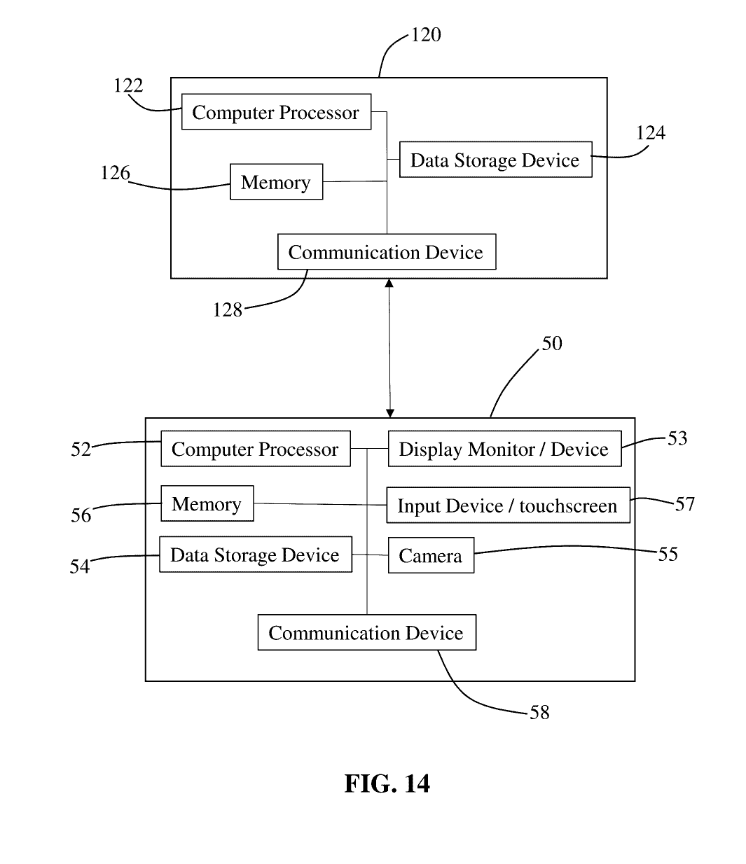

Referring now to FIGS. 13 and 14, at least one embodiment of the present invention is further directed to a system 100 for prevention of prescription drug diversion and compliance assurance. Particularly, in addition to the drug dispensing assembly 10, such as the container assembly 20 and control assembly 50, the system 100 of at least one embodiment includes a remote management system 120 which is communicatively connected with the drug dispensing assembly 10, for example, via a computer network 15.

Specifically, the computer network 15, as used herein, may include virtually any communication network or collection of networks capable of facilitating the practice of the present invention in the intended manner, such as the World Wide Web or Internet, telecommunication networks such as 3G, 4G, LTE, etc., Intranet, Wide Area Networks, Bluetooth, Near-field Communication (NFC) networks, etc., or any combination thereof.

Further, the management system or processing device 120 of at least one embodiment of the system 100 may include any one or more computer systems structured to store, communicate and/or process data or media in accordance with the present invention, and, as shown in the schematic of FIG. 14, may therefore include a computer processor 122, data storage device 124, memory 126, one or more communication devices or hardware 128 (e.g., network device(s), web server(s), etc.) Particularly, the management system and/or processing device 120 of at least one embodiment of the present invention comprises one or more web servers or data servers, including software and hardware to receive requests and to communicate data, information, media, web pages, applications, etc. via the network 15 in accordance with the present invention.

More in particular, the computer processor 122 may include, for example, any device cooperatively structured to execute or implement computer instructions, software, etc. The data storage device 124, as used herein, may include one or more internal, external or removable hard disk drives, CD/DVD, USB drives, solid state drives, virtual drives, could-based storage drives, or other types of volatile or non-volatile memory. Further, the memory device 126 as used herein, may include but is not limited to random access memory (RAM) or other like devices configured to implement the present invention in the intended manner, for example, by at least temporary storing and assisting with the execution of one or more applications or computer programs capable of implementing the system 100 and method 200 described herein. Moreover, the communication device 128 may include a network communication hardware/software component structured to facilitate communication between the drug dispensing device 10 and/or third-party devices 150 described herein.

It should also be noted that the control assembly 50 of at least one embodiment may also include any one or more computer systems (e.g., dedicated control assembly or personal electronic device) structured to store, communicate and/or process data or media in accordance with the present invention, and, as also shown in the schematic of FIG. 14, may include a computer processor 52, data storage device 54, memory 56, and one or more communication devices or hardware 58. Particularly, the computer processor 52 may include, for example, any device cooperatively structured to execute or implement computer instructions, software, etc. The data storage device 54, as used herein, may include one or more internal, external or removable memory or drives, USB drives, solid state drives, virtual drives, could-based storage drives, or other types of volatile or non-volatile memory. Further, the memory device 56 as used herein, may include but is not limited to random access memory (RAM) or other like devices configured to implement the present invention in the intended manner, for example, by at least temporary storing and assisting with the execution of one or more applications or computer programs capable of facilitating the implementation of the system 100 and method 200 described herein. Moreover, the communication device 58 may include a network communication hardware/software component structured to facilitate communication with the management system 120 and/or third-party devices 150 described herein. Furthermore, the control assembly 50 of at least one embodiment further includes a display 53 for displaying information, media and instructions (e.g., to the patient or user), an input 57 (e.g., touchscreen, keyboard, mouse, etc.) and an image capturing device 55 such as a camera for recording video, images, and/or audio.

Still referring to the system 100 as shown, for example, in FIGS. 13 and 14, in at least one embodiment, the management system 120 is structured to store profile/account information or patient identification information corresponding to the users or patients of the system 100. For instance, a user or patient may register with the system 100 by providing unique patient information, such as name, address, phone number, email address, social security number, username, password, etc. In some implementations, only a single account can be assigned to each social security number. This is an effort to reduce fraudulent accounts, “doctor shopping,” or users trying to go to multiple physicians to receive another prescription of controlled or scheduled drugs. In addition, for added security and compliance, certain embodiments may only allow a single control assembly 50 (e.g., cell phone) to be paired with a particular container 20.

Further, in at least one embodiment, each time a user or patient accesses a dose of medication, prescription access media is generated and/or communicated from the control assembly 50 to a secure and confidential database or other data storage device on the management system 120, for example, via computer network 15. The prescription access media may include a video or images of the patient retrieving the medication, taking the medication, and showing that medication was actually consumed (e.g., by opening his or her mouth and moving his or her tongue up, down, left and right). Additionally, the prescription access media may include the date and time of the access, the location of the access (e.g., via GPS technology provided in the control assembly 50), and patient identification information (e.g., name, username, social security number).

Accordingly, the remote management system 120 may be structured to receive the prescription access media from a plurality of different control assemblies 50 (used by a plurality of different patients) and store the prescription access media for subsequent retrieval and processing. For instance, via an authorized third-party monitor device 150, prescription access media can be reviewed, monitored and analyzed in order to determine whether the patient has complied with the prescription regimen. Certain embodiments of the management system 120 may generate prescription access reports, including a list or identification of prescription access media, access to videos, images, etc., charts, graphs, or visual representations and/or analysis of the prescription access media. The reports may be retrieved by authorized third parties, including, but in no way limited to, physicians, medical personnel, law enforcement officers, probation officers, family members, patients, etc. by logging into the system 120 with an appropriate profile or credentials. Other embodiments may communicate the report(s) or prescription access media directly to third party devices 150, for example, by email, fax, SMS, text message, etc. The reports and/or media may be communicated on a periodic basis (e.g., daily, weekly, monthly) or on demand, when requested.

It should also be noted, however, that in certain embodiments, the prescription access media may be stored locally, for instance, on the control assembly 50. This may be particularly true, although not limited to, the embodiment with a dedicated control assembly 50, as opposed to a personal electronic device, such as the patient's phone. As shown, for example by arrows A1 and A2 in FIG. 13, the control assembly 50 (whether a dedicated device or a personal electronic device) may then be brought or mailed to the physician, law enforcement, etc. in order to show the prescription access media to the physician, law enforcement, etc. Other embodiments may allow or require the control assembly 50 to be brought or mailed to the remote management system 120 or remote office where it can be reviewed by trained staff, for example, or an automated software or analysis program.

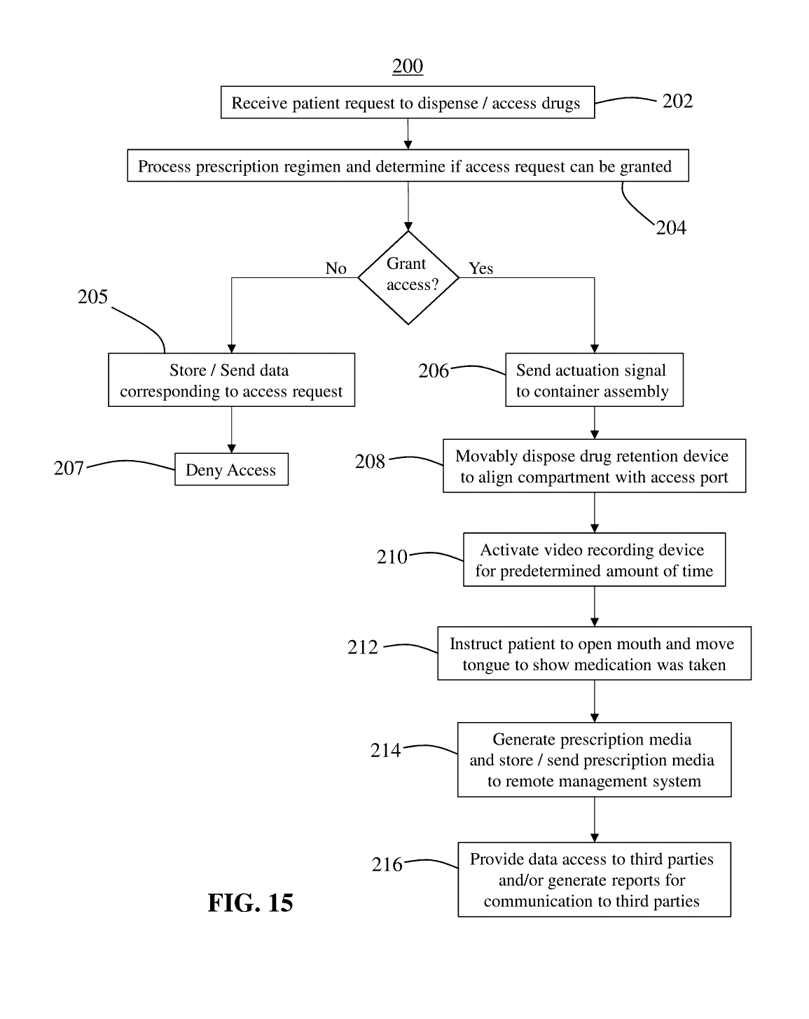

Referring now to FIG. 15, at least one embodiment of the present invention further includes a method for prevention of prescription drug diversion and compliance assurance, generally referenced as 200. For instance, as shown at 202, the method 200 includes receiving a patient request at or via a control assembly to provide access to a prescription drug or other medication, controlled substance, etc. Particularly, in the embodiment where the control assembly 50 is a personal electronic device, such as the patient's cellular or mobile phone, the patient will first connect the control assembly 50 to the container 20. The connection may be made via wired connection (USB, for example), Bluetooth, WiFi, etc. The container assembly may include a universal adapter, connection, etc. or a plurality of different cables, adapters, or connectors that can connect to a plurality of different devices, phones, or computers.

Once the control assembly, such as, for example, the phone or other personal electronic device is connected, and the corresponding application or website is accessed, the patient is ready to begin the request. Other embodiments, as described herein, may include a dedicated control assembly 50 that may already be connected to the container 20 or that may need to be plugged in or connected wirelessly. In any event, the patient may access the control assembly 50 by entering a password, code, biometric credentials, etc. in order to request that the control assembly 50 send a signal to the container 20 to dispense or provide access to medication.

The method 200 further includes the step of processing the patient request and determining whether to grant access to the prescription drug based upon a predetermined access control prescription regimen, as shown at 204. In particular, a prescription regimen is associated with the patient profile and/or the drug dispensing assembly 10 itself which controls whether the patient can access the contents of the container 20. For instance, the prescription regimen may limit the number of doses the patient may take in a period of time, or frequency of doses the patient can take. Thus, processing the request requires access to the prescription regimen as well as historical access data corresponding to the patient and/or the drug dispensing assembly 10. Such information and/or data may be contained or stored on the control assembly 50 itself, or stored in a remote location, such as, but not limited to the remote management system 120 described herein. For instance, when the physician prescribes the medication, he or she may program the control assembly 50 with the prescription regimen or he or she may log into the management system 120 and enter or select a prescription regimen and associate that regimen with the patient or control assembly 50.

It should also be noted that many prescription regimens may allow the patient to request doses on demand or when needed, and without exceeding a maximum allowed amount, particularly for pain medication, as opposed to a set timing schedule of x doses every y hours. In such a case, the present invention allows the patient to request a dose when needed or on demand, and the system and method will determine, based upon the prescription regimen and the patient's historical access data (e.g., when the last dose(s) was/were taken), whether the patient can have a dose or another dose.

If the method 200 determines that the patient cannot have access to the medication, for example, based upon the prescription regimen and/or historical access data, as shown at 205, the method 200 may record and store information pertaining to the request (e.g., the patient's name, date and time of the request, location, etc.) The method 200 will deny access 207, for example, by not unlocking the container 20 or by not sending a control or actuation signal to the container 20 (and thereby not positioning the drug retention device 30 or compartment 32 there in an aligned relation with e the access port 25). The information pertaining to the request may be stored locally on the control assembly 50 or remotely, for example, on the management system 120. It should be noted that the control assembly 50 may temporarily store the information locally, and later transfer the information to the remote management system 120, particularly when/if a connection to the network 15 is low or non-existent.

On the other hand, if the method 200 determines that the patient can administer or take another dose of medication, then, as shown at 206, the method 200 will communicate an actuation signal (e.g., from the control assembly 50) to the container assembly 20. As provided herein, doing so will cause the drug retention device to be movably disposed within the container 20 so as to align an individual compartment 32 with the access port 25 for selective removal of the prescription drug(s) contained therein 208.

Still referring to FIG. 15, the method 200 includes activating an image capturing device 210 such as a video camera in order to record or obtain visual depictions of the patient removing the medication and taking the medication, for example. It should be noted that, although in the flow chart of FIG. 15, activating the image capturing device 210 appears under steps 206 and 208, the various embodiments of the present invention may activate the image capturing device prior to steps 206 and 208, simultaneously with steps 206 and 208, between steps 206 and 208, immediately after steps 206 and 208, etc. in order to accomplish the goals of the present invention. For instance, in one embodiment, the image capturing device may be automatically activated upon the patient entering an access code, such as at step 202. This may allow capturing of images for both allowed access and denied access. Other embodiments may automatically activate the image capturing device when access is granted and prior to movably disposing the drug retention device within the container. This allows time for the camera to record the patient removing the medication from the container and subsequently taking the medication.

Accordingly, certain embodiments automatically activate the camera or otherwise turn the camera on for a predetermined amount of time. This requires the patient to remove the medication or drug and consume the medication or drug during the predetermined timeframe (i.e., while the camera is on). The automatic activation of the camera may be synchronized with one or more certain events, e.g., when the patient requests access to the medication, when or before the drug retention device rotates or moves to align a compartment with the access port, etc. The automatic activation and synchronization of the camera with predetermined events may thus prevent or minimize the ability for the patient to deceive the system, for example, by recording another video at another time or adding old video claiming it is the correct video showing the actual consumption. Further embodiments may prevent the patient from accessing the video files, modifying the video files, or deleting the video files. This also helps prevent deception.

Furthermore, the image capturing device may be activated for a predetermined amount of time, for example, 10 seconds, 15 seconds, 20 seconds, etc. This requires the patient to retrieve the medication from the container and properly administer the medication during this predetermined time that the video is recording. Failure to do so could result in a determination that the patient is abusing the medication.

In addition, some embodiments include a stand or support structure for the control assembly to sit upon or engage within. This allows the control assembly, particularly when the control assembly is the patient's personal electronic device, to be oriented in a proper direction, i.e., toward the container 20 and the patient, in order to capture both the container 20 and the patient during the retrieval and administering phase.

In certain embodiments, the method 200 further includes a step of directing or instructing the patient what to do 212, for example, by providing visual or written instructions on the display of the control assembly or audible instructions through the speakers of the control assembly. The instructions may include, but not limited to, directions for the patient to place the medication into his or her mouth, swallow the medication, open his or her mouth toward the camera, and move his or her tongue around (e.g., up, down, left and right). This minimizes the possibility that the patient is “cheeking” the medication, i.e., hiding the medication in his or her mouth without swallowing it, in order to subsequently remove the medication and possibly sell, abuse or otherwise divert it. Other embodiments may also instruct the patient to place the medication in front of the camera prior to taking it, in order for the camera to record the size, shape, color and/or indicia printed on the medication.

The method 200 further includes generating prescription access media 214, for example, using the patient identification information (profile, ID, name, social security number, etc.), date, time, and video or other image(s) captured. The prescription access media can then be stored locally or remotely, as provided herein, and access granted 216 to third parties or third party devices 150. For instance, the third parties may log into the remote management system to request or obtain reports or information corresponding to the prescription access media of certain patients. This allows the third party to monitor the patient's intake of the medication for compliance purposes and for purposes of issuing subsequent prescriptions for refills or other medications.

In certain embodiments, the third party access may be provided in real-time via a live feed over the network 15 wherein medical personnel, physicians, doctors, law enforcement officers, compliance officers, compliance employees, family members, etc. can watch the patient consume the medication in real time. For instance, the control assembly 50 may transmit a live video feed over the network either directly to a third party device or via the management system in order to allow the third party to have live monitoring access.

Furthermore, various embodiments of the present invention may include the step of analyzing or processing the prescription access media to determine whether the patient has complied with the prescription or attempted to divert the medication, for example. The analysis and processing of the prescription access media may be conducted by the prescribing physician, another physician, law enforcement, or trained independent staff members (e.g., with access to the prescription access media at the remote management system, described herein). Other embodiments may include automated software or program(s) for automatically reviewing the video(s) and other prescription access media to determine or preliminarily determine whether compliance has been achieved.

Further embodiments of the present invention may include generating a report or reports based upon the prescription access media and the analysis thereof. For example, report(s) may be generated by the staff member(s) or the automated software analysis program based upon the analysis of the prescription access media. The report(s) may then be provided to the physician, for example, either periodically (e.g., weekly or monthly) or upon request. This allows the prescribing physician to monitor the patient's access and consumption of the prescriptions and provides the prescribing physician with invaluable information when determining whether to prescribe further medications to the same patient.

This written description provides an illustrative explanation and/or account of the present invention. It may be possible to deliver equivalent benefits and insights using variations of the sequence, steps, specific embodiments and methods, without departing from the inventive concept. This description and these drawings, therefore, are to be regarded as illustrative and not restrictive.

Now that the invention has been described,

What is claimed is:

1. A drug dispensing assembly to facilitate prevention of prescription drug diversion, said drug dispensing assembly comprising:
a container assembly, said container assembly comprising an interior portion at least partially defined by a container housing,
said container assembly further comprising a drug retention device movably disposed within said interior portion, said drug retention device comprising a plurality of individual compartments each configured to at least temporarily retain a drug therein,
said container assembly further comprising an access port disposed at least partially through a portion of said housing, wherein said drug retention device is movably disposed within said container assembly to align one of said plurality of individual compartments with said access port at a time,
said container assembly being disposed in a communicative relation with a control assembly, said container assembly being actuated by said control assembly to movably dispose said drug retention device within said housing and align said one of said plurality of individual compartments with said access port upon request and according to an access control prescription regimen, and
said control assembly further comprising an image recording device, said image recording device being automatically actuated and structured to record media upon actuation of said container assembly.

2. The drug dispensing assembly as recited in claim 1 wherein said drug retention device is rotationally disposed within said container assembly.

3. The drug dispensing assembly as recited in claim 2 further comprising a driving mechanism secured to said drug retention device for rotationally disposing said drug retention device within said container assembly according to the access control prescription regimen.

4. The drug dispensing assembly as recited in claim 1 wherein said container assembly further comprises a locking assembly to restrict access to said plurality of individual compartments of said drug retention assembly that are not aligned with said access port.

5. The drug dispensing assembly as recited in claim 4 wherein said container assembly comprises a body portion and a lid, said lid being secured to said body portion via said locking assembly.

6. The drug dispensing assembly as recited in claim 1 wherein said control assembly comprises a personal electronic device.

7. The drug dispensing assembly as recited in claim 6 wherein the access control prescription regimen is managed via a mobile application accessible via said personal electronic device.

8. The drug dispensing assembly as recited in claim 1 further comprising a picker configured to extract a drug from one of said individual compartments through said access port.

9. The drug dispensing assembly as recited in claim 8 wherein said picker is substantially transparent.

10. A system for facilitating prevention of prescription drug diversion, said system comprising:
a drug dispensing assembly and a remote management system each disposed in a communicative relation with one another via a computer network, said remote management system comprising a computer processor, storage device, memory and communication device,
said drug dispensing assembly comprising a container assembly communicatively connected to a control assembly, said container assembly comprising a plurality of drug dosages therein,
said control assembly being structured to actuate said container assembly to provide controlled patient prescription access to at least one of said plurality of drug dosages at a time according to a patient request and an access control prescription regimen,
said control assembly further comprising a video recording device structured to automatically activate and record video upon actuation of said container assembly by said control assembly in accordance with the patient request and the access control prescription regimen,
said control assembly comprising a communication module for communicating prescription access media to said remote management system, said prescription access media comprising said recoded video, patient identification information, and a date and time corresponding to each patient prescription access via said drug dispensing assembly, and
said remote management system being configured to receive and store said prescription access media on said storage device, and process said prescription access media for generating at least one prescription access report, said prescription access media and prescription access report being remotely accessible by an authorized third-party monitor device.

11. The system as recited in claim 10 wherein said container assembly comprises a drug retention device movably disposed within an interior portion of said container assembly, said drug retention device comprising a plurality of individual compartments each configured to at least temporarily retain a drug dose therein.

12. The system as recited in claim 11 wherein said container assembly comprises an access port disposed at least partially through a housing thereof, said drug retention device being movably disposed within said housing to align one of said plurality of individual compartments with said access port at a time.

13. The system as recited in claim 12 wherein said drug retention device is rotationally disposed within said housing.

14. The system as recited in claim 13 wherein said container assembly further comprises a locking assembly to restrict access to said plurality of individual compartments of said drug retention assembly that are not aligned with said access port.

15. The system as recited in claim 14 wherein said container assembly comprises a generally disc-shaped body portion and a lid, said lid being secured to said body portion via said locking assembly.

16. The system as recited in claim 14 wherein said control assembly comprises a personal electronic device.

17. A method for facilitating prevention of prescription drug diversion, the method comprising:
receiving a patient request at a control assembly to provide access to a prescription drug, the control assembly being disposed in a communicative relation with a container assembly, the container assembly comprising a drug retention device movably disposed within the container assembly relative to an access port,
processing the patient request and determining whether to grant access to the prescription drug based upon a predetermined access control prescription regimen,
if access to the prescription drug is granted, then:
communicating an actuation signal from the control assembly to the container assembly to movably dispose the drug retention device within the container assembly and align an individual compartment thereof with the access port for selective removal of the prescription drug contained therein,
automatically activating a video recording device for a predetermined amount of time for recording the patient removing the prescription drug from the drug retention device and administering the prescription drug according to a prescription regimen, and
generating prescription access media corresponding to the controlled patient access to the prescription drug, the prescription access media comprising recorded video and patient identification information.

18. The method as recited in claim 17 further comprising communicating the prescription access media to a remote management system for storage and third-party access thereof.

19. The method as recited in claim 18 further comprising analyzing the prescription access media to determine whether evidence of diversion or deception is present.

20. The method as recited in claim 19 further comprising generating at least one report based upon the analysis of the prescription access media.

21. The method as recited in claim 20 further comprising communicating the report to a third party upon request.

22. The method as recited in claim 21 further comprising defining the control assembly as comprising a personal electronic device.
